(19) United States
(12) Patent Application Publication
(10) Pub. No.: US 2018/0336809 A1
(43) Pub. Date: Nov. 22, 2018

(54) DISPLAY PANEL

(71) Applicant: AU OPTRONICS CORPORATION, Hsin-chu (TW)

(72) Inventors: Peng-Bo XI, Hsin-chu (TW); Sung-Yu SU, Hsin-chu (TW)

(21) Appl. No.: 15/981,034

(22) Filed: May 16, 2018

(30) Foreign Application Priority Data
May 16, 2017 (TW) 106116069

(51) Int. Cl. G09G 3/00; G09G 3/20

(52) U.S. Cl. CPC G09G 3/006; G09G 3/20; G09G 2320/0209; G09G 2330/12; G09G 2310/0297

(57) ABSTRACT

A display panel includes: a display region, a plurality of data lines, a de-multiplexing circuit, and an operation switching circuit. The de-multiplexing circuit has a plurality of input terminals coupled to a plurality of data driving signal lines, a plurality of output terminals coupled to the plurality of data lines, and at least one de-multiplexing control terminal coupled to at least one driving control signal. The operation switching circuit is configured to switch a conduction status between the at least one de-multiplexing control terminal of the de-multiplexing circuit and a second control signal line according to a voltage of a first control signal line.

### CROSS-REFERENCE TO RELATED PATENT APPLICATION

This non-provisional application claims priority to and the benefit of, pursuant to 35 U.S.C. § 119(a), patent application Serial No. 106116069 filed in Taiwan on May 16, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a display panel, and in particular, to a display panel using a multiplex drive.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Display panels are widely applied to various consumer electronics, for example, computer screens, mobile phones, and televisions. In recent years, the display panel is already integrated with a touch function, a user may directly perform a touch operation, for example, selecting a point, moving, or drawing on the panel with a finger or a stylus. Before delivery of the display panel, to confirm that functions are normal, array testing needs to be performed to detect electric property of a pixel array. However, in a process of driving pixel data, the display panel applicable to an array test circuit may generate excessive noise. Consequently, operating of another function (for example, a touch function) on the display panel may be affected. Therefore, how to design a display panel that can reduce noise of the panel is one of subjects that the industry is working on.

### SUMMARY

According to an aspect of the present invention, a display panel is provided. The display panel includes: a display region, a plurality of data lines, a de-multiplexing circuit, and an operation switching circuit. The de-multiplexing circuit has a plurality of input terminals coupled to a plurality of data driving signal lines, a plurality of output terminals coupled to the plurality of data lines, and at least one de-multiplexing control terminal coupled to at least one driving control signal. The operation switching circuit is configured to switch a conduction status between the at least one de-multiplexing control terminal of the de-multiplexing circuit and a second control signal line according to a voltage of a first control signal line.

According to another aspect of the present invention, a display panel is provided. The display panel includes: a display region, a plurality of data lines, a de-multiplexing circuit, an operation switching circuit, and a test switch circuit. The de-multiplexing circuit has a plurality of input terminals coupled to a plurality of data driving signal lines, a plurality of output terminals coupled to the plurality of data lines, and at least one de-multiplexing control terminal coupled to at least one driving control signal. The operation switching circuit is configured to switch a conduction status between the at least one de-multiplexing control terminal of the de-multiplexing circuit and a second control signal line according to a voltage of a first control signal line. The test switch circuit is configured to switch a conduction status between a panel test circuit and the plurality of data lines according to a voltage of a third control signal line. The display panel is switched between a test mode and a display mode, in the test mode, voltages of the first control signal line, the second control signal line, and the third control signal line are all direct-current voltages, and in the display mode, the voltages of the first control signal line, the second control signal line, and the third control signal line are all direct-current voltages.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic diagram of a display panel according to an embodiment;

FIG. 2 is a block diagram of a display panel according to an embodiment of the present invention;

FIG. 3 is a block diagram of a display panel including a test switch circuit according to an embodiment of the present invention;

FIG. 4 is a schematic circuit diagram of a display panel according to an embodiment of the present invention;

FIG. 5 is a schematic diagram of a display panel that is operated in a display mode according to an embodiment of the present invention; and

FIG. 6 is a schematic diagram of a display panel that is operated in a test mode according to an embodiment of the present invention.

### DETAILED DESCRIPTION

The detailed features and advantages of the present invention are described below in great detail through the following embodiments, and the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention. The following embodiments further describe the viewpoints of the present invention, but are not intended to limit the scope of the present invention in any way.

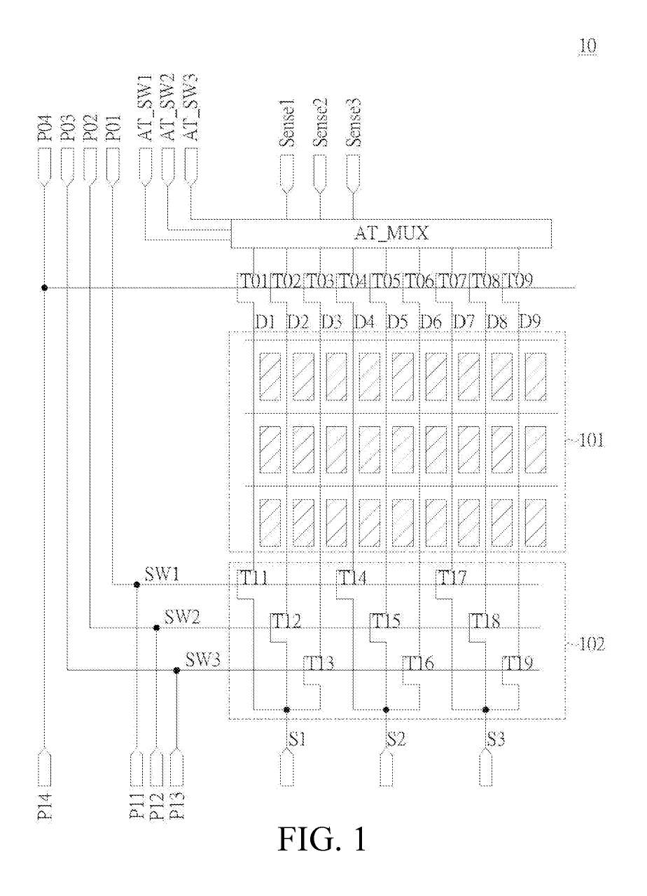

FIG. 1 is a schematic diagram of a display panel according to an embodiment. In this embodiment, the display panel 10 includes a display region 101 and a de-multiplexing circuit 102. The display region 101 may include a plurality of pixels. Each pixel may, for example, include a red subpixel, a green subpixel, and a blue subpixel, which may be used to display image data. In the figure, blocks filled with slash lines represent subpixels.

In this embodiment, a plurality of 1-to-3 de-multiplexers is used in the de-multiplexing circuit 102, and may be configured to selectively provide data drive signals S1 to S3 from a source driver to one of data lines D1 to D9 of the display panel 10. For example, the de-multiplexing circuit 102 may selectively provide the data drive signal S1 from the source driver to one of the data lines D1 to D3 of the display panel according to driving control signals SW1 to SW3, and selectively provide the data drive signal S2 to one of the data lines D4 to D6 of the display panel, and selectively provide the data drive signal S3 to one of the data lines D7 to D9 of the display panel. In this example, the data lines D1, D4, and D7, for example, correspond to red subpixels, the data lines D2, D5, and D8, for example, correspond to green subpixels, and the data lines D3, D6, and D9, for example, correspond to blue subpixels.

In this embodiment, the 1-to-3 de-multiplexers used in the de-multiplexing circuit 102 may be implemented by thin film transistors (TFTs). In another embodiment of the display panel, a different type of de-multiplexer, such as a 1-to-2 de-multiplexer and a 1-to-4 de-multiplexer, may be used in the de-multiplexing circuit 102, or the de-multiplexing circuit 102 may be implemented in a different manner. In the following content of this specification, the 1-to-3 de-multiplexer is used as an embodiment for description, but the present invention is not limited thereto. A person skilled in the art should understand that in a structure of the display panel that is disclosed below, another type of de-multiplexing circuit may be used.

The upper part of FIG. 1 shows a test circuit. The test circuit, for example, includes a test multiplexing circuit AT_MUX. When the display panel 10 performs a test, an input pad on the upper part provides a test control signal. For example, input pads P01 to P04 and AT_SW1 to AT_SW3 are included. An output pad on the upper part reads data from the panel. For example, the output pad includes output pads Sense1 to Sense3. The test multiplexing circuit AT_MUX may, for example, selectively provide outputs of the plurality of data lines D1 to D9 to the output pads Sense1 to Sense3. The quantity of lines between the test circuit and the panel may be reduced by using the test multiplexing circuit AT_MUX. FIG. 1 shows only a part of the test circuit, and the test circuit may further include a circuit providing input test data.

During a panel test, a control signal is input from a pin on the upper part of the panel. In this case, switches (transistors T01 to T09) on the upper part of the panel are turned on, so that test data can be normally input, and a result of the panel test is read. Switches (transistors T11 to T19) on the lower part of the panel are turned off, to isolate external impact from the lower part of the panel. The input pad P04 provides a high gate voltage level VGH, and the input pads P01 to P03 provide low gate voltage levels VGLs.

When the panel displays data, a control signal is input from a pin on the lower part of the panel. In this case, the switches (the transistors T01 to T09) on the upper part of the panel are turned off, to isolate external impact from the upper part of the panel. The switches (the transistors T11 to T19) on the lower part of the panel are turned on, so that the data drive signals S1 to S3 can be written to pixels. Therefore, the input pad P14 should provide a low gate voltage level VGL. The input pads P11 to P13 provide communication signals changing with times as driving control signals SW1 to SW3, so as to alternately turn on the switches (the transistors T11 to T19) in the de-multiplexing circuit 102, and normally drive pixel data.

In the embodiment shown in FIG. 1, in the display panel 10, the input pads P01 to P03 on the upper part of the panel are routed to the input pads P11 to P13 on the lower part of the panel by using lines. Therefore, the lines have relatively long lengths, and occupy a relatively large area, resulting in extra load of the circuit. In addition, when the panel displays data, the communication signals are transmitted on these lines. The rapidly changing driving control signals SW1 to SW3 may generate a noise coupling effect for touch sensing, resulting in incorrect actions of some other circuits, for example, resulting in an incorrect action of touch sensing.

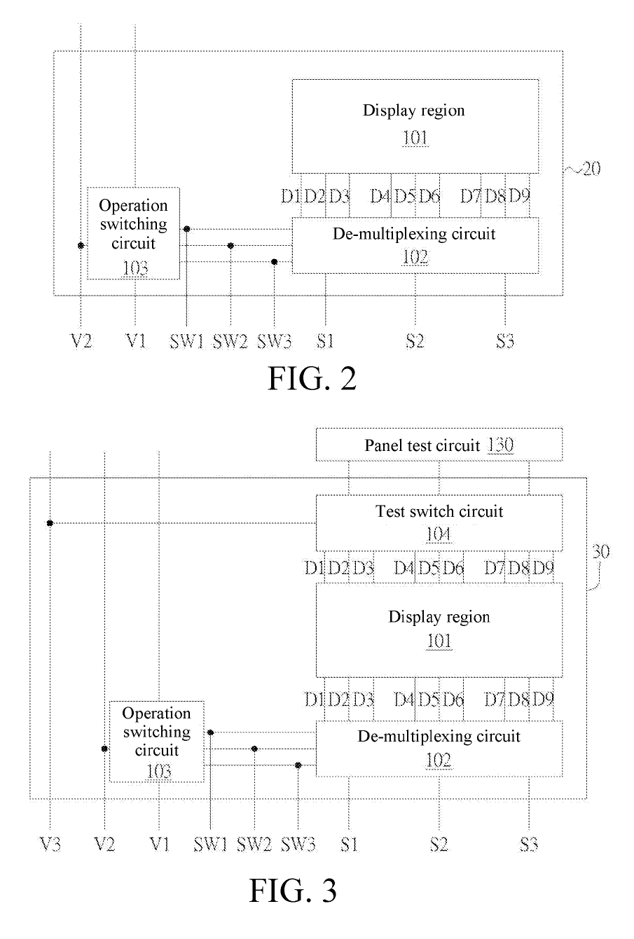

The present invention provides a display panel, to effectively reduce noise of the panel. FIG. 2 is a block diagram of a display panel according to an embodiment of the present invention. The display panel 20 includes: a display region 101, a plurality of data lines D1 to D9, a de-multiplexing circuit 102, and an operation switching circuit 103. The de-multiplexing circuit 102 has a plurality of input terminals coupled to a plurality of data driving signal lines S1 to S3. The de-multiplexing circuit 102 has a plurality of output terminals coupled to the plurality of data lines D1 to D9. The de-multiplexing circuit 102 has at least one de-multiplexing control terminal coupled to at least one driving control signals SW1 to SW3. The operation switching circuit 103 is configured to switch a conduction status between the at least one de-multiplexing control terminal of the de-multiplexing circuit 102 and a second control signal line V2 according to a voltage of a first control signal line V1.

As shown in FIG. 2, lines related to the driving control signals SW1 to SW3 are only on the lower part of the display panel 20, and are not routed to the upper part of the panel. Therefore, a noise coupling effect of the driving control signals SW1 to SW3 for touch sensing may be reduced. In addition, the first control signal line V1 and the second control signal line V2 both transmit direct-current voltage signals. Therefore, the noise of the panel can also be effectively reduced. A detailed operation mode and a control signal are described below.

FIG. 3 is a block diagram of a display panel including a test switch circuit according to an embodiment of the present invention. Compared with the embodiment shown in FIG. 2, the display panel 30 shown in FIG. 3 further includes the test switch circuit 104. The test switch circuit 104 is configured to switch a conduction status between a panel test circuit 130 and data lines D1 to D9 according to a voltage of a third control signal line V3. In this embodiment, lines related to driving control signals SW1 to SW3 are also on the lower part of the display panel 30, and are not routed to the upper part of the panel. Moreover, a first control signal line V1, a second control signal line V2, and a third control signal line V3 all transmit direct-current voltages. Therefore, noise of the panel can be effectively reduced.

The quantity of data driving signal lines S1 to S3 is m (in this embodiment, to simplify the figure, m=3 is used as an example, and in an actual panel circuit, m may be several hundred). The quantity of the data lines D1 to D9 is n (in this embodiment, to simplify the figure, n=9 is used as an example, and in an actual panel circuit, n may be related to pixel resolution of the panel, for example, n=1920). A ratio of n to m represents a size of a de-multiplexer used in the de-multiplexing circuit 102. In this embodiment, n/m=3, which indicates that a 1-to-3 de-multiplexer is used in the de-multiplexing circuit 102. The quantity of the driving control signals SW1 to SW3 is p (in the figure, p=3 is used as an example). p is related to the size of the de-multiplexer used in the de-multiplexing circuit 102. m, n, and p are positive integers, n>m>1, and p≥2. In an embodiment, p=(n/m). For example, if a 1-to-3 de-multiplexer is used, the 1-to-3 de-multiplexer is controlled by three driving control signals SW1 to SW3.

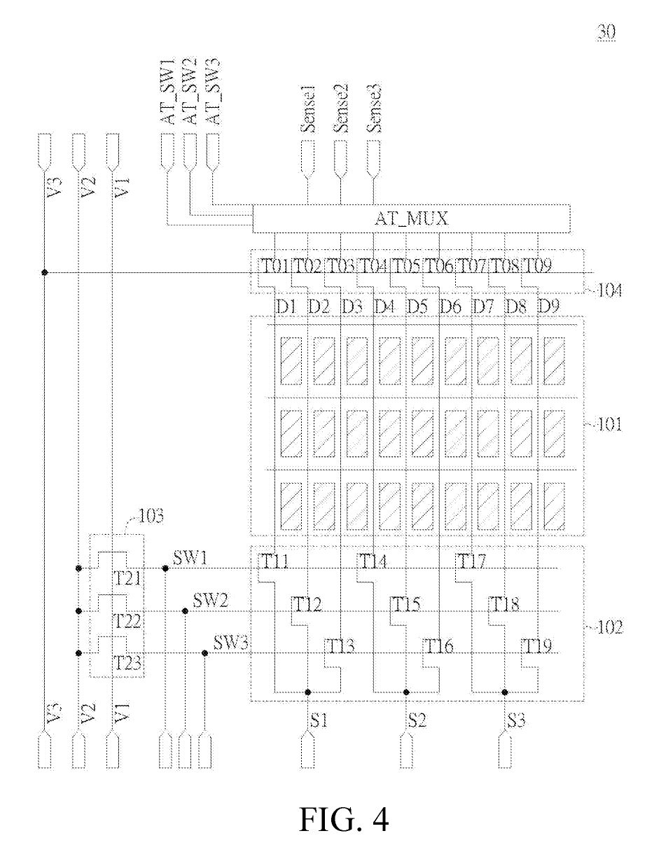

FIG. 4 is a schematic circuit diagram of a display panel according to an embodiment of the present invention. FIG. 4 shows a circuit implementation corresponding to FIG. 3. For example, a demultiplexing circuit 102 may include transistors T11 to T19. A test switch circuit 104 may include transistors T01 to T09. An operation switching circuit 103 may include transistors T21 to T23. The transistors T01 to T09, T11 to T19, and T21 to T23, for example, may be all NMOS transistors. In this embodiment, the quantity of transistors and the types of the transistors are merely exemplary implementations, and the present invention is not limited thereto. Each switch element may alternatively be implemented as a PMOS transistor, a CMOS transistor, or another electronic switch element.

In the embodiment shown in FIG. 4, the de-multiplexing circuit 102 is disposed on a first side (for example, the lower part) of a display region 101, and the operation switching circuit 103 is also disposed on the first side (for example, the lower part) of the display region 101. The de-multiplexing circuit 102 and the operation switching circuit 103 are disposed on the same side of the display region 101, so that actual lines for transmitting the driving control signals SW1 to SW3 are relatively short. Therefore, the communication signals are limited to only a small region on the panel, thereby reducing noise impact caused by the communication signals to the panel.

In an embodiment, a test switch circuit 104 is disposed on a second side (for example, the upper part) of the display region 101 opposite to the first side. The test switch circuit 104 includes transistors T01 to T09, and transistors T01 to T09 are respectively coupled to data lines D1 to D9. Each of the transistors T01 to T09 has a control terminal coupled to a third control signal line V3.

A first control signal line V1, a second control signal line V2, and the third control signal line V3 are all extended from the first side of the display region 101 to the second side of the display region 101. In a test mode, voltages of the first control signal line V1, the second control signal line V2, and the third control signal line V3 are all direct-current voltages, and in a display mode, the voltages of the first control signal line V1, the second control signal line V2, and the third control signal line V3 are all direct-current voltages. Therefore, noise impact can be reduced.

The operation switching circuit 103 is configured to control a conduction status between the second control signal line V2 and the de-multiplexing circuit 102. An implementation is shown in FIG. 4. The operation switching circuit 103 includes transistors T21 to T23. The quantity of the transistors in the operation switching circuit 103 may be equal to p (the quantity of the driving control signals). Each of the transistors T21 to T23 is coupled to each de-multiplexing control terminal of the de-multiplexing circuit 102. That is, in this embodiment, a corresponding transistor may be disposed in the operation switching circuit 103 for each driving control signal.

In the embodiment shown in FIG. 4, the de-multiplexing circuit 102 has three de-multiplexing control terminals. Each de-multiplexing control terminal is coupled to a transistor in the operation switching circuit 103. The transistor T21 has a control terminal coupled to the first control signal line V1, a first terminal coupled to the second control signal line V2, and a second terminal coupled to a de-multiplexing control terminal of the de-multiplexing circuit 102. In addition, connection manners for the transistor T22 and the transistor T23 are similar to a connection manner for the transistor T21, and details are not described herein again. In this example, an NMOS transistor is used in the de-multiplexing circuit 102. A control terminal of each of the transistors T11 to T19 may be coupled to the second control signal line V2 by using the operation switching circuit 103.

If a CMOS architecture is used in the de-multiplexing circuit 102 for implementation, for example, a 1-to-3 de-multiplexer that is implemented by using three NMOS transistors and three PMOS transistors, the de-multiplexing circuit 102 may have six de-multiplexing control terminals. Control terminals of the three NMOS transistors may be coupled to the second control signal line V2 by using the operation switching circuit 103, and control terminals of the three PMOS transistors may be coupled to a fourth control signal line V4 by using the operation switching circuit 103. That is, the operation switching circuit 103 may be further configured to switch a conduction status between the de-multiplexing control terminal of the de-multiplexing circuit 102 and the fourth control signal line V4 according to the voltage of the first control signal line V1. Voltage polarities of the fourth control signal line V4 and the second control signal line V2 may be different. For example, when the voltage of the second control signal line V2 is at a direct current low gate voltage level VGL, the voltage of the fourth control signal line V4 is at a direct current high gate voltage level VGH.

The display panel 30 may be switched between a test mode and a display mode. For example, before delivery of the display panel 30, the display panel 30 may be operated in the test mode, to verify whether functions of the panel are normal. After delivery of the display panel 30, the display panel 30 may be operated in the display mode, to display image data. When the display panel 30 is operated in the display mode, a related driving signal is provided from a pad on the lower part of the panel. When the display panel 30 is operated in the test mode, a related driving signal is provided from a pad on the upper part of the panel.

Control signals in the display mode and the test mode are described below. Reference may be made to the schematic diagram of the display panel shown in FIG. 3. In the display mode, the de-multiplexing control terminal of the de-multiplexing circuit 102 is disconnected from the second control signal line V2, and the de-multiplexing circuit 102 is controlled by the driving control signals SW1 to SW3. The panel test circuit 130 is disconnected from the data lines D1 to D9. In this case, the display region 101 is not affected by the panel test circuit 130. The voltage of the second control signal line V2 is at a direct current reference voltage level, for example, is at a ground reference voltage level GND.

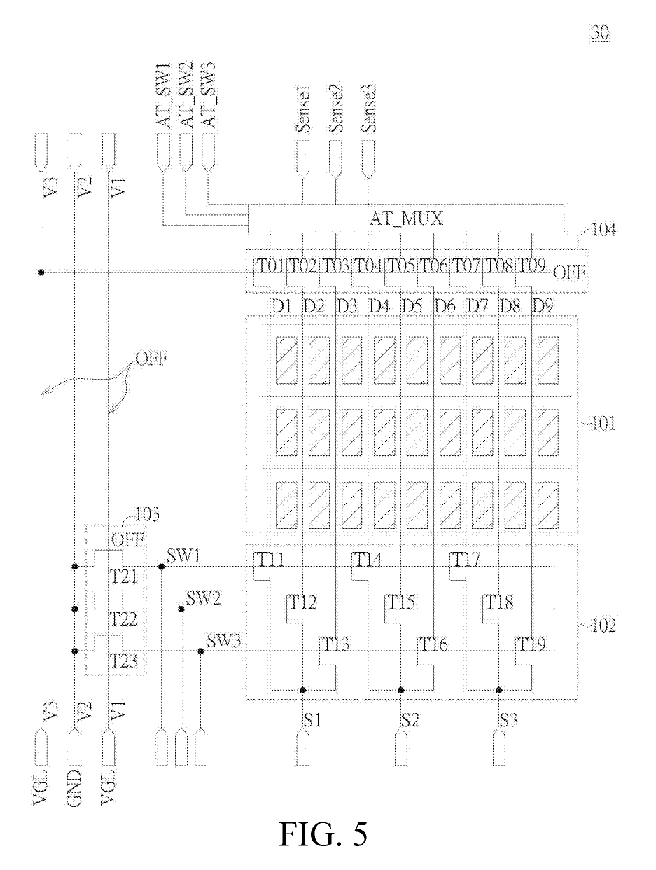

FIG. 5 is a schematic diagram of a display panel that is operated in a display mode according to an embodiment of the present invention. The circuit structure in FIG. 5 is the same as that in FIG. 4. In the display mode, a first terminal of a transistor T21 is disconnected from a second terminal of the transistor T21, a first terminal of a transistor T22 is disconnected from a second terminal of the transistor T22, a first terminal of a transistor T23 is disconnected from a second terminal of the transistor T23, and a de-multiplexing circuit 102 is controlled by driving control signals SW1 to SW3.

As shown in the embodiment in FIG. 5, the transistors T21 to T23 may be NMOS transistors. In the display mode, a voltage of a first control signal line V1 is at a direct current low gate voltage level VGL. Therefore, the transistors T21 to T23 are not conducted. In another implementation, if the transistors T21 to T23 are PMOS transistors, in the display mode, the voltage of the first control signal line V1 may be at a direct current high gate voltage level VGH, so that the transistors T21 to T23 are not conducted.

A test switch circuit 104 includes transistors T01 to T09. In the display mode, first terminals of the transistors T01 to T09 are disconnected from second terminals of the transistors T01 to T09, to isolate impact caused by a panel test circuit 130 to data lines D1 to D9. The transistors T01 to T09 may be NMOS transistors. In the display mode, a voltage of a third control signal line V3 is at a direct current low gate voltage level VGL. Therefore, the transistors T01 to T09 are not conducted. If the transistors T01 to T09 are PMOS transistors, the voltage of the third control signal line V3 may be at a direct current high gate voltage level VGH, so that the transistors T01 to T09 are not conducted.

In the embodiment shown in FIG. 5, in the display mode, the voltage of the first control signal line V1 is at the direct current low gate voltage level VGL, a voltage of a second control signal line V2 is at the direct current reference voltage level, for example, is at a ground reference voltage level GND, and the voltage of the third control signal line V3 is at the direct current low gate voltage level VGL. An input pad on the upper part of the display panel 30, for example, is in a floating state.

Subsequently, control signals in a test mode are described. Reference may be made to the schematic diagram of the display panel shown in FIG. 3. In the test mode, the de-multiplexing control terminal of the de-multiplexing circuit 102 is conducted to the second control signal line V2, and the voltage of the second control signal line V2 controls the de-multiplexing circuit 102, so that the data driving signal lines S1 to S3 are disconnected from the data lines D1 to D9.

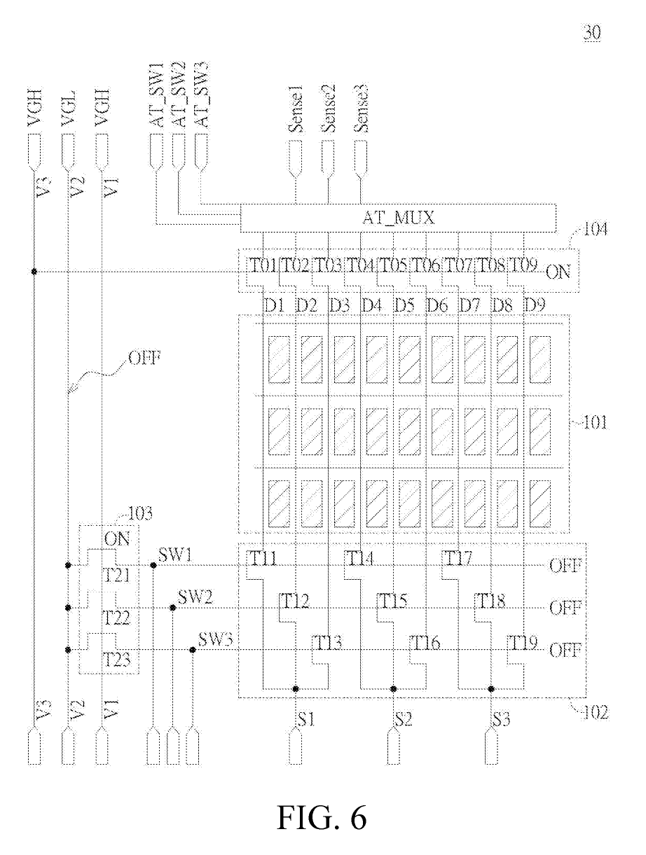

FIG. 6 is a schematic diagram of a display panel that is operated in a test mode according to an embodiment of the present invention. The circuit structure in FIG. 6 is the same as that in FIG. 4. In the test mode, a first terminal of a transistor T21 is conducted to a second terminal of the transistor T21, a first terminal of a transistor T22 is conducted to a second terminal of the transistor T22, a first terminal of a transistor T23 is conducted to a second terminal of the transistor T23, and a de-multiplexing circuit 102 is controlled by a voltage of a second control signal line V2.

As shown in the embodiment in FIG. 6, the transistors T21 to T23 may be NMOS transistors. In the test mode, a voltage of a first control signal line V1 is at a direct current high gate voltage level VGH. Therefore, the transistors T21 to T23 are conducted. If the transistors T21 to T23 are PMOS transistors, the voltage of the first control signal line V1 may be at a direct current low gate voltage level VGL, so that the transistors T21 to T23 are conducted.

The de-multiplexing circuit 102 includes transistors T11 to T19, for example, NMOS transistors. In the test mode, the voltage of the second control signal line V2 is at the direct current low gate voltage level VGL, so that the transistors T11 to T19 are turned off. If the transistors T11 to T19 are PMOS transistors, the voltage of the second control signal line V2 may be at the direct current high gate voltage level VGH, so that the transistors T11 to T19 are turned off.

A test switch circuit 104 includes transistors T01 to T09. In the test mode, first terminals of the transistors T01 to T09 are conducted to second terminals of the transistors T01 to T09, so that a panel test circuit 130 may write data to data lines D1 to D9 or read data from the data lines D1 to D9. As shown in the embodiment in FIG. 6, the transistors T01 to T09 may be NMOS transistors. In the test mode, a voltage of a third control signal line V3 is at a direct current high gate voltage level VGH. Therefore, the transistors T01 to T09 are conducted. If the transistors T01 to T09 are PMOS transistors, the voltage of the third control signal line V3 may be at the direct current low gate voltage level VGL, so that the transistors T01 to T09 are conducted.

In the embodiment shown in FIG. 6, in the test mode, the voltage of the first control signal line V1 is at the direct current high gate voltage level VGH, the voltage of the second control signal line V2 is at the direct current low gate voltage level VGL, and the voltage of the third control signal line V3 is at the direct current high gate voltage level VGH. An input pad on the lower part of the display panel 30, for example, is in a floating state.

According to the display panel in the foregoing embodiments of the present invention, voltages of a first control signal line V1, a second control signal line V2, and a third control signal line V3 are all direct-current voltages in the display mode or the test mode. Therefore, power consumption can be effectively reduced, noise of the panel may be reduced, and interference to touch sensing is reduced, thereby avoiding an incorrect action. In addition, by means of the display panel in the present invention, the quantity of required pins on the upper part of the panel during testing can be reduced, and required routes from the upper part of the panel to the lower part of the panel can be reduced, thereby effectively reducing circuit load. A better design for a panel with a narrow bezel can be implemented by using a multiplex drive and a multiplex array test.

Although the present disclosure has been described by using the foregoing implementations, is the implementations are not used to limit the present invention. A person skilled in the art can make various modifications and improvements without departing from the spirit and scope of the present disclosure. Therefore, the protection scope of the present disclosure should be subject to the scope defined by the appended claims.

What is claimed is:

1. A display panel, comprising:
a display region;
a plurality of data lines;
a de-multiplexing circuit, having a plurality of input terminals coupled to a plurality of data driving signal lines, a plurality of output terminals coupled to the plurality of data lines, and at least one de-multiplexing control terminal coupled to at least one driving control signal; and
an operation switching circuit, configured to switch a conduction status between the at least one de-multiplexing control terminal of the de-multiplexing circuit and a second control signal line according to a voltage of a first control signal line.

2. The display panel according to claim 1, wherein the de-multiplexing circuit is disposed on a first side of the display region, and the operation switching circuit is also disposed on the first side of the display region.

3. The display panel according to claim 1, wherein a quantity of the plurality of data driving signal lines is m, a quantity of the plurality of data lines is n, a quantity of the at least one driving control signal is p, m, n, and p are positive integers, n>m>1, and p≥2.

4. The display panel according to claim 3, wherein the operation switching circuit comprises at least one transistor, a quantity of the at least one transistor is p, and each of the at least one transistor is coupled to each of the at least one de-multiplexing control terminal of the de-multiplexing circuit.

5. The display panel according to claim 4, wherein each of the at least one transistor has a control terminal coupled to the first control signal line, a first terminal coupled to the second control signal line, and a second terminal coupled to one of the at least one de-multiplexing control terminal of the de-multiplexing circuit.

6. The display panel according to claim 1, further comprising a test switch circuit, configured to switch a conduction status between a panel test circuit and the plurality of data lines according to a voltage of a third control signal line.

7. The display panel according to claim 6, wherein the de-multiplexing circuit is disposed on a first side of the display region, the operation switching circuit is also disposed on the first side of the display region, and the test switch circuit is disposed on a second side of the display region opposite to the first side of the display region.

8. The display panel according to claim 7, wherein the first control signal line, the second control signal line, and the third control signal line are all extended from the first side of the display region to the second side of the display region.

9. The display panel according to claim 6, wherein the test switch circuit comprises a plurality of transistors, each of the plurality of transistors is coupled to each of the plurality of data lines, and each of the plurality of transistors has a control terminal coupled to the third control signal line.

10. The display panel according to claim 1, wherein the operation switching circuit is further configured to switch a conduction status between the at least one de-multiplexing control terminal of the de-multiplexing circuit and a fourth control signal line according to the voltage of the first control signal line.

11. A display panel, comprising:
a display region;
a plurality of data lines;
a de-multiplexing circuit, having a plurality of input terminals coupled to a plurality of data driving signal lines, a plurality of output terminals coupled to the plurality of data lines, and at least one de-multiplexing control terminal coupled to at least one driving control signal;
an operation switching circuit, configured to switch a conduction status between the at least one de-multiplexing control terminal of the de-multiplexing circuit and a second control signal line according to a voltage of a first control signal line; and
a test switch circuit, configured to switch a conduction status between a panel test circuit and the plurality of data lines according to a voltage of a third control signal line, wherein
the display panel is switched between a test mode and a display mode, in the test mode, voltages of the first control signal line, the second control signal line, and the third control signal line are all direct-current voltages, and in the display mode, the voltages of the first control signal line, the second control signal line, and the third control signal line are all direct-current voltages.

12. The display panel according to claim 11, wherein in the display mode, the at least one de-multiplexing control terminal of the de-multiplexing circuit is disconnected from the second control signal line, the panel test circuit is disconnected from the plurality of data lines, and the voltage of the second control signal line is at a direct current reference voltage level.

13. The display panel according to claim 12, wherein the operation switching circuit comprises at least one transistor, each of the at least one transistor has a control terminal coupled to the first control signal line, a first terminal coupled to the second control signal line, and a second terminal coupled to one of the at least one de-multiplexing control terminal of the de-multiplexing circuit, and in the display mode, the first terminal of each of the at least one transistor of the operation switching circuit is disconnected from the second terminal of each of the at least one transistor of the operation switching circuit.

14. The display panel according to claim 13, wherein each of the at least one transistor of the operation switching circuit is an NMOS transistor, and in the display mode, the voltage of the first control signal line is at a direct current low gate voltage level.

15. The display panel according to claim 12, wherein the test switch circuit comprises a plurality of transistors, each of the plurality of transistors is coupled to each of the plurality of data lines, each of the plurality of transistors has a control terminal coupled to the third control signal line; and in the display mode, a first terminal of the plurality of transistors of the test switch circuit is disconnected from a second terminal of the plurality of transistors of the test switch circuit.

16. The display panel according to claim 15, wherein each of the plurality of transistors of the test switch circuit is an NMOS transistor, and in the display mode, the voltage of the third control signal line is at a direct current low gate voltage level.

17. The display panel according to claim 11, wherein in the test mode, the at least one de-multiplexing control terminal of the de-multiplexing circuit is conducted to the second control signal line, the panel test circuit is conducted to the plurality of data lines, the voltage of the second control signal line control the de-multiplexing circuit, so that the plurality of data driving signal lines is disconnected from the plurality of data lines.

18. The display panel according to claim 17, wherein the operation switching circuit comprises at least one transistor, each of the at least one transistor has a control terminal coupled to the first control signal line, a first terminal coupled to the second control signal line, and a second terminal coupled to one of the at least one de-multiplexing control terminal of the de-multiplexing circuit, and in the test mode, the first terminal of each of the at least one transistor of the operation switching circuit is conducted to the second terminal of each of the at least one transistor of the operation switching circuit.

19. The display panel according to claim 18, wherein each of the at least one transistor of the operation switching circuit is an NMOS transistor, and in the test mode, the voltage of the first control signal line is at a direct current high gate voltage level.

20. The display panel according to claim 19, wherein in the test mode, the voltage of the second control signal line is at a direct current low gate voltage level.
